(19) United States
(12) Patent Application Publication
(10) Pub. No.: US 2023/0283615 A1
(43) Pub. Date: Sep. 7, 2023

(54) ACCESS DECISION DEVICE, ACCESS DECISION METHOD AND COMPUTER READABLE MEDIUM

(71) Applicant: Mitsubishi Electric Corporation, Tokyo (JP)

(72) Inventors: Takumi MORI, Tokyo (JP); Masahiro FUJITA, Tokyo (JP); Yoichi SHIBATA, Tokyo (JP); Nori MATSUDA, Tokyo (JP)

(73) Assignee: Mitsubishi Electric Corporation, Tokyo (JP)

(21) Appl. No.: 18/196,715

(22) Filed: May 12, 2023

Related U.S. Application Data
(63) Continuation of application No. PCT/JP2021/000278, filed on Jan. 7, 2021.

(51) Int. Cl. H04L 9/40

(52) U.S. Cl. CPC H04L 63/105; H04L 63/20

(57) ABSTRACT

An ontology generation unit (110) generates information that represents an access policy for each attribute of access in a hierarchical structure, as a plurality of ontologies (30). An application rule generation unit (120) generates an application rule (40). A policy candidate extraction unit (140) acquires an access request (51), and extracts an ontology (30) that includes an attribute included in the access request (51) as an access policy candidate from the plurality of ontologies. An access rule determination unit (150) specifies a plurality of access policies that match the attribute included in the access request (51) form the access policy candidate, applies the application rule (40) to the plurality of access policies, and determines an access rule. A propriety decision unit (160) decides propriety of access based on the access rule.

### CROSS REFERENCE TO RELATED APPLICATIONS

This application is a Continuation of PCT International Application No. PCT/JP2021/000278, filed on Jan. 7, 2021, which is hereby expressly incorporated by reference into the present application.

### TECHNICAL FIELD

The present invention relates to an access decision device, an access decision method and an access decision program.

### BACKGROUND ART

Secrecy of companies is kept on-premises or in a private cloud, and is accessed from various environments such as inside a company or outside a company, in the daytime or nighttime, and from a domestic location or an overseas location. Thus, there has been a need for a technique to perform authentication or access control strictly depending on attributes of users such as a degree of reliability, and to reduce risk of information leakage.

There has been a method to decide an access policy based on attributes or contents of files by machine learning; however, there is a problem that it is not explicable with this method. It is impossible to evaluate validity of the access policy to be applied, and to fulfill accountability in the event of an incident.

Further, machine learning is generally computationally expensive. There is a need to reconstruct, i.e., relearn a classifier depending on changes of input data. For configuration of a high-precision inference engine, an enormous amount of learning data is necessary.

Additionally, there is a problem in machine learning that it is difficult to define error conditions beforehand. An behavior to be taken in error conditions, i.e., in the case of lack of policies to apply, has not been defined, and denying access to be on the safe side impairs the availability.

Further, it is difficult to perform access control in consideration of a plurality of conditions with conventional access control lists (ACLs).

Patent Literature 1 discloses a technique wherein a template of an access policy is prepared, and the template of access policy is applied to a file to be accessed.

### CITATION LIST

### Patent Literature

Patent Literature 1: JP 2005-099982 A

### SUMMARY OF INVENTION

### Technical Problem

According to a technique disclosed in Patent Literature 1, it is possible to follow an access policy when a file is copied, or the file itself is changed. However, it is impossible to follow the access policy when a plurality of attributes in an access condition such as an author, a secret grade of a file or an access path is changed. Further, by the technique disclosed in Patent Literature 1, it is impossible to secure the availability when access policies fall into an error condition.

In the present invention, it is possible to follow access policies even when a plurality of attributes in an access condition are changed by determining an access rule through applying an application rule to the plurality of access policies. Further, it is possible to secure the availability even when the plurality of access policies fall into an error condition.

### Solution to Problem

There is provided according to one aspect of the present invention an access decision device to decide propriety of access to a file, the access decision device includes:
an ontology generation unit to generate information that represents an access policy to describe an access condition for each attribute of access in a hierarchical structure as a plurality of ontologies;
an application rule generation unit to generate an application rule that includes a rule in a case of combining access policies, and a rule in a case wherein access policies conflict with each other;
a policy candidate extraction unit to acquire an access request being an access request for the file, which includes a plurality of attributes, and to extract as an access policy candidate an ontology that includes an attribute included in the access request from the plurality of ontologies;
an access rule determination unit to specify a plurality of access policies that match the attribute included in the access request from the access policy candidate, to apply the application rule to the plurality of access policies, and to determine an access rule for the file; and
a propriety decision unit to decide propriety of access to the file based on the access rule.

### Advantageous Effects of Invention

An access decision device according to the present invention determines an access rule by applying an application rule to a plurality of access policies. Therefore, by the access decision device according to the present invention, it is possible to follow access policies even when a plurality of attributes in an access condition are changed. Further, it is possible to secure the availability even when the plurality of access policies fall into an error condition.

### BRIEF DESCRIPTION OF DRAWINGS

FIG. 1 is an example of an overall configuration of a file access system according to a first embodiment;

FIG. 2 is a configuration example of an access decision device according to the first embodiment;

FIG. 3 is a flow diagram illustrating an ontology generation process according to the first embodiment;

FIG. 4 is a diagram illustrating an example of ontology according to the first embodiment;

FIG. 5 is a diagram illustrating an example of ontology according to the first embodiment;

FIG. 6 is a diagram illustrating an example of ontology according to the first embodiment;

FIG. 7 is a diagram illustrating an example of an undefined policy in ontology according to the first embodiment;

FIG. 8 is a flow diagram illustrating an application rule generation process according to the first embodiment;

FIG. 9 is a diagram illustrating an example of a rule when access policies in the application rule clash with each other according to the first embodiment;

FIG. 10 is a flow example illustrating an implementation phase according to the first embodiment;

FIG. 11 is a schematic diagram illustrating a concrete example of the implementation phase according to the first embodiment;

FIG. 12 is a detailed flow diagram of an access rule determination process according to the first embodiment;

FIG. 13 is a configuration example of an access decision device according to a first variation of the first embodiment;

FIG. 14 is a diagram illustrating an example of ontology according to a second variation of the first embodiment;

FIG. 15 is a schematic diagram illustrating an access role decision process according to a third variation of the first embodiment;

FIG. 16 is a schematic diagram illustrating an example of ontology according to a second embodiment;

FIG. 17 is a diagram illustrating another example of ontology according to the second embodiment;

FIG. 18 is a configuration example of an access decision process according to a third embodiment; and

FIG. 19 is a schematic diagram illustrating an example of an ontology generation process and an access rule determination process according to a third embodiment.

### DESCRIPTION OF EMBODIMENTS

Hereinafter, embodiments of the present invention will be described using diagrams. In each diagram, same elements or corresponding elements are denoted by same reference numerals. In the following explanation of the embodiments, description of the same or the corresponding elements is omitted or simplified appropriately. Further, in the following diagrams, the relation between sizes of each configurational element may differ from that of actual elements. Furthermore, in the description of the embodiments, directions or positions such as above, below, left, right, front, back, obverse and reverse may be indicated. These indications are description applied for ease of explanation, which does not limit the positions, directions and orientations of devices, instruments and parts, etc.

### First Embodiment

### Explanation of Configuration

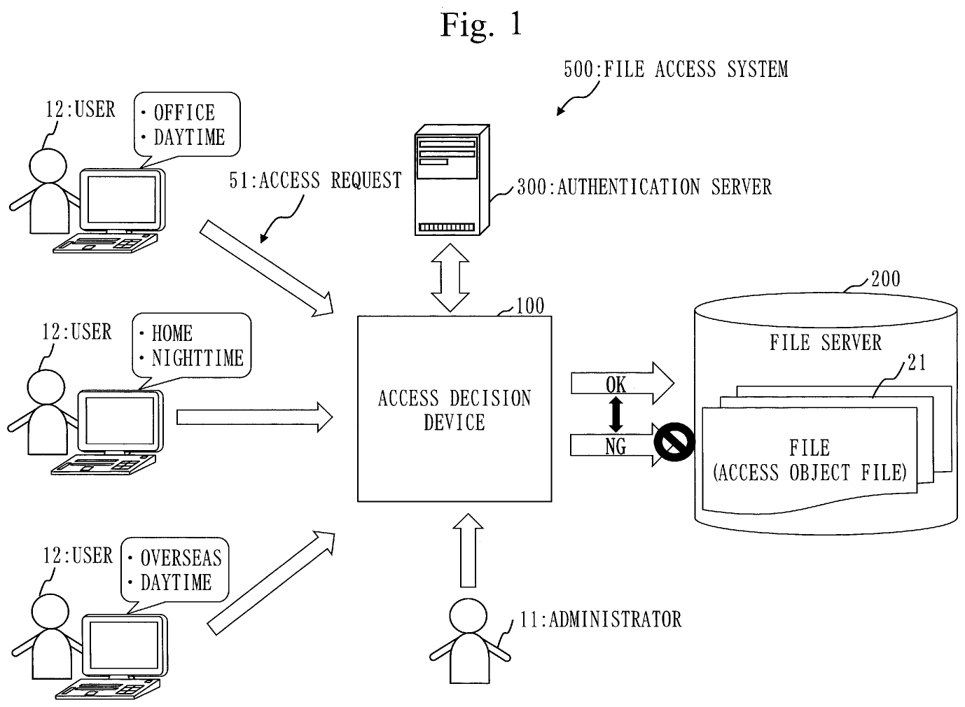

FIG. 1 is a diagram illustrating an example of an overall configuration of a file access system 500 according to a present embodiment.

A file access system 500 includes an access decision device 100 and a file server 200.

The access decision device 100 accepts an access request 51 from a user 12, evaluates reliability of the user 12 in real time, and decides whether an access by the user 12 is acceptable.

The file server 200 stores a file 21 being various access object documents. The file 21 includes a confidential document, a document of company secret or a disclosed document.

The user 12 accesses the file 21 from various environments. For example, the user 12 accesses the file 21 from various environments in such as manner as to make an access from inside of a company during the daytime, to make an access from one's home at night, or to make an access from overseas during the daytime.

Further, the file access system 500 may include an authentication server 300 in addition to the access decision device 100 and the file server 200. The access decision device 100 may have a configuration whereby reliability of the user 12 is evaluated in real time in cooperation with the authentication server 300, and whether access by the user 12 is permitted is decided.

An administrator 11 of the file access system 500 performs processes such as to set, change or update information necessary for an access decision process by the access decision device 100.

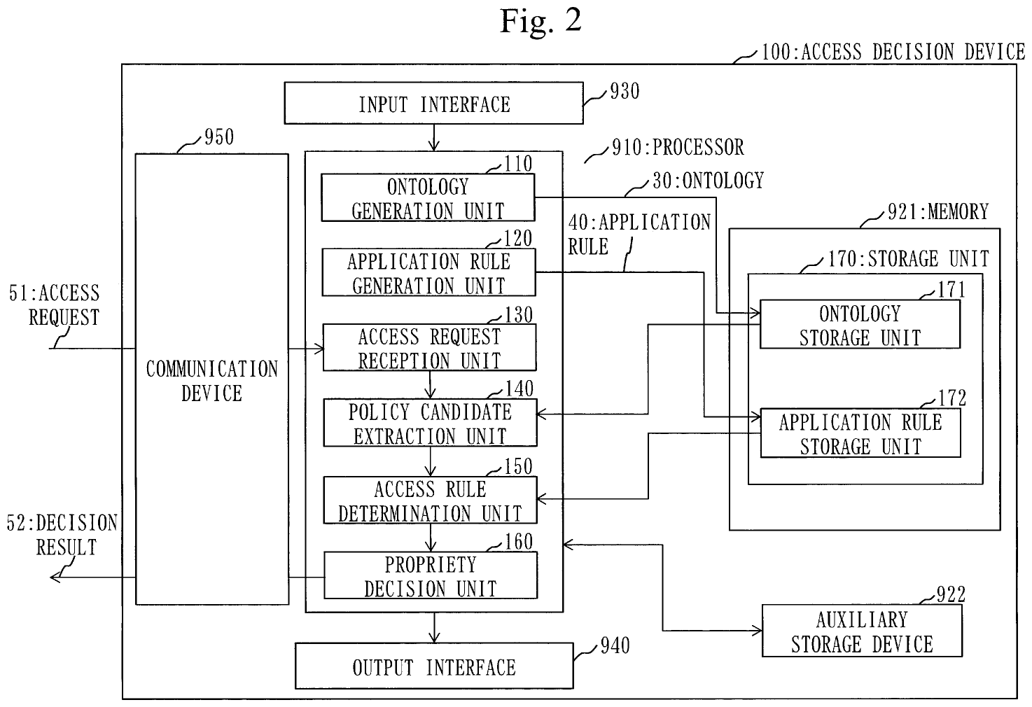

A configuration example of the access decision device 100 according to the present embodiment will be described using FIG. 2.

The access decision device 100 is a computer. The access decision device 100 may include a processor 910, and additionally other hardware components such as a memory 921, an auxiliary storage device 922, an input interface 930, an output interface 940 and a communication device 950. The processor 910 connects with other hardware components via signal lines, and controls these other hardware components.

The access decision device 100 includes, as functional components, an ontology generation unit 110, an application rule generation unit 120, an access request reception unit 130, a policy candidate extraction unit 140, an access rule determination unit 150, a propriety decision unit 160 and a storage unit 170. The storage unit 170 includes an ontology storage unit 171 and an application rule storage unit 172.

Functions of the ontology generation unit 110, the application rule generation unit 120, the access request reception unit 130, the policy candidate extraction unit 140, the access rule determination unit 150 and the propriety decision unit 160 are realized by software. The storage unit 170 is included in the memory 921. The storage unit 170 may be included in the auxiliary storage device 922, or may be included in the memory 921 and the auxiliary storage device 922 dispersively.

The processor 910 is a device to execute an access decision program. The access decision program is a program to realize the functions of the ontology generation unit 110, the application rule generation unit 120, the access request reception unit 130, the policy candidate extraction unit 140, the access rule determination unit 150 and the propriety decision unit 160.

The processor 910 is an IC (integrated circuit) to perform arithmetic processing. The processor 910 is, for example, a CPU (central processing unit), a DSP (digital signal processor), or a GPU (graphics processing unit).

The memory 921 is a storage device to store data temporarily. The memory 921 is an SRAM (static random access memory) or a DRAM (dynamic random access memory), for example.

The auxiliary storage device 922 is a storage device to retain data. The auxiliary storage device 922 is an HDD, for example. Further, the auxiliary storage device 922 may be a portable storage medium such as an SD (registered trademark) memory card, a CF, a NAND flash, a flexible disk, an optical disk, a compact disk, a Blue-ray (registered trademark) disk, or a DVD. HDD is an abbreviation for Hard Disk Drive. SD (registered trademark) is an abbreviation for Secure Digital. CF is an abbreviation for CompactFlash (registered trademark). DVD is an abbreviation for Digital Versatile Disk.

The input interface 930 is a port to be connected to an input device such as a mouse, keyboard or a touch panel. The input interface 930 is, for example, a USB (universal serial bus) terminal. The input interface 930 may be a port to be connected to a LAN (local area network).

The output interface 940 is a port whereto a cable of an output device such as a display is connected. The output interface 940 is a USB terminal or an HDMI (registered trademark) (high definition multimedia interface) terminal, for example. The display is an LCD (liquid crystal display), for example. The output interface 940 is also referred to as an indicator interface.

The communication device 950 includes a receiver and a transmitter. The communication device 950 is connected to a communication network such as a LAN, the Internet or a telephone line. The communication device 950 is a communication chip or an NIC (network interface card), for example.

An access decision program is executed in the access decision device 100. The access decision program is read into the processor 910, and executed by the processor 910. The memory 921 stores not only the access decision program but also an OS (operating system). The processor 910 executes the access decision program while executing the OS. The access decision program and the OS may be stored in the auxiliary storage device 922. The access decision program and the OS stored in the auxiliary storage device 922 are loaded into the memory 921, and executed by the processor 910. A part or the whole of the access decision program may be incorporated into the OS.

The access decision device 100 may include a plurality of processors to replace the processor 910. These plurality of processors share execution of the access decision program. Each processor is a device to execute the access decision program similarly as the processor 910.

Data, information, signal values and variable values used, processed or output by the access decision program are stored in the memory 921, the auxiliary storage device 922, or a register or a cache memory inside the processor 910.

“Unit” of each unit of the ontology generation unit 110, the application rule generation unit 120, the access request reception unit 130, the policy candidate extraction unit 140, the access rule determination unit 150 and the propriety decision unit 160 may be replaced with “circuit”, “step”, “procedure”, “process” or “circuitry”. The access decision program makes a computer execute an ontology generation process, an application rule generation process, an access request reception process, a policy candidate extraction process, an access rule determination process and a propriety decision process. “Process” of the ontology generation process, the application rule generation process, the access request reception process, the policy candidate extraction process, the access rule determination process and the propriety decision process may be replaced with “program”, “program product”, “computer-readable storage medium storing a program” or “computer-readable recording medium recording a program”. Further, the access decision method is a method performed by the access decision device 100 executing the access decision program.

The access decision program may be provided by being stored in a computer-readable recording medium. Further, the access decision program may be provided as a program product.

### Explanation of Operation

Next, description is made on the access decision process being an operation by the access decision device 100 according to the present embodiment. The operation procedure of the access decision device 100 corresponds to the access decision method. Further, the program to realize the operations of the access decision device 100 corresponds to the access decision program.

The access decision process is divided into a preparation phase and an implementation phase.

The preparation phase includes an ontology generation process to generate ontology 30, and an application rule generation process to generate an application rule 40.

The implementation phase includes a policy candidate extraction process to extract a plurality of access policy candidates 301, an access rule determination process to determine an access rule 41 for the file 21, and a propriety decision process to decide whether to permit access to the file 21.

### Preparation Phase

### Ontology Generation Process

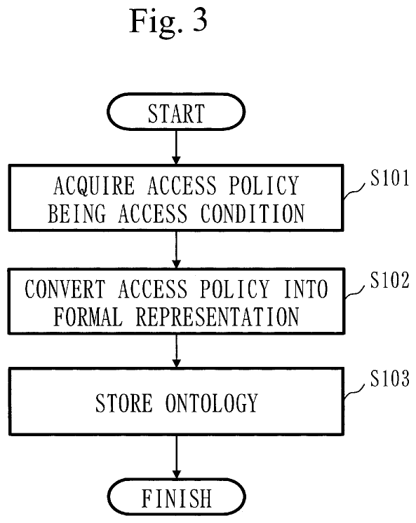

FIG. 3 is a flow diagram to illustrate an ontology generation process according to the present embodiment.

In the ontology generation process, the ontology generation unit 110 generates as an ontology 30 information wherein an access policy 32 indicating an access condition for each attribute 31 of access is represented in a hierarchical structure. The ontology generation unit 110 generates a plurality of ontologies 30 for each attribute 31 of access. The ontology generation unit 110 is an interface or a tool used for generation of the ontologies 30 by the administrator 11. The administrator 11 generates the ontologies 30 using the ontology generation unit 110.

Specifically, as follows.

In Step S101, the ontology generation unit 110 acquires an access policy 32 being an access condition used for deciding whether to permit access. The access policy 32 is input for each attribute 31 of access.

The attribute 31 of access is an attribute of an access condition. The attribute 31 is a type whereto the access policy 32 used for deciding whether to permit access belongs, such as “job”, “access path”, “place”, “affiliation”, “authentication state”, “position” or “information on a file”.

The access policy 32 is an access condition. For example, when the attribute 31 is “job”, the access policy 32 describes an access condition such as “when a user 12 is in charge of Project 2, permit when an author of an access object file is in Department A and a secret grade is other than strictly confidential”. Further, as an access condition, an interaction operation with a user like additional authentication may be included. Details in a case of additional authentication will be described in a third embodiment.

In Step S102, the ontology generation unit 110 converts the access policy 32 into a formal expression. Specifically, the ontology generation unit 110 generates ontologies 30 indicating the access policy 32 for each attribute 31 in a hierarchical structure. The ontologies 30 are, for example, in a tree structure.

Further, the ontologies 30 are assumed to include an undefined policy 323 to describe a policy in a case wherein an access policy is undefined. The policy in the case wherein the access policy is undefined is also referred to as an undefined rule.

The ontologies 30 may be generated using the ontology generation unit 110 by the administrator 11, or may be automatically generated by the ontology generation unit 110 from the access policy 32 input.

In Step S103, the ontology generation unit 110 stores the ontologies 30 in an ontology storage unit 171. Since the ontologies 30 are generated for each attribute 31, a plurality of ontologies 30 are stored in the ontology storage unit 171. It is common that a plurality of ontologies 30 are stored in a list structure; however, they may be stored in any form. Further, the ontologies 30 are stored by using the attribute 31 as an index.

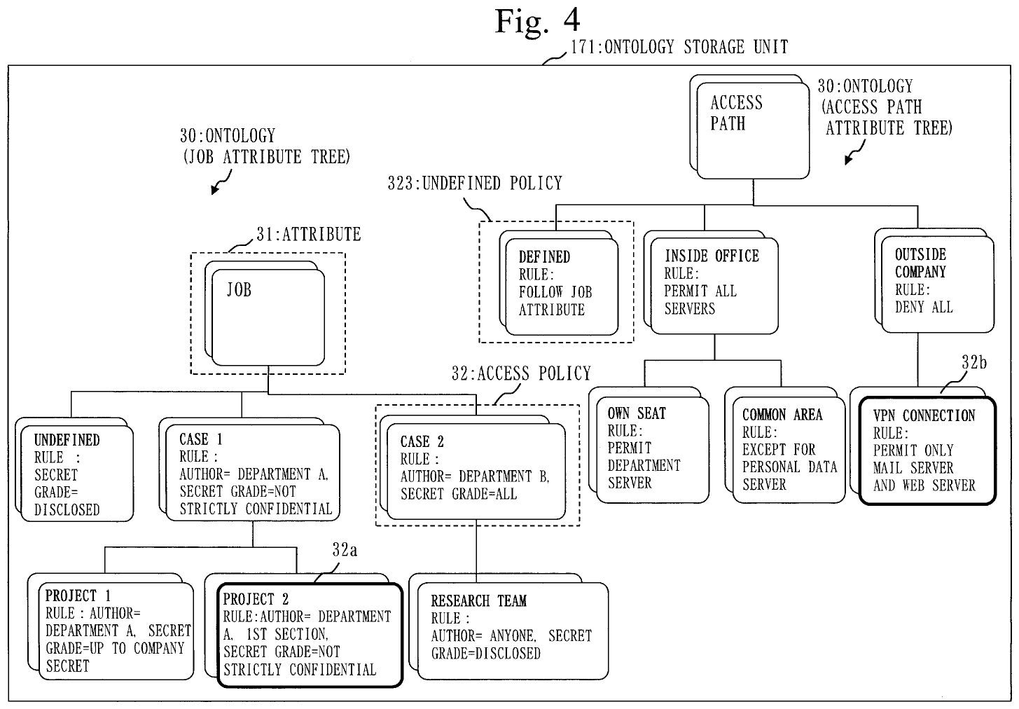

FIG. 4 through FIG. 6 are diagrams illustrating examples of the ontologies 30 according to the present embodiment.

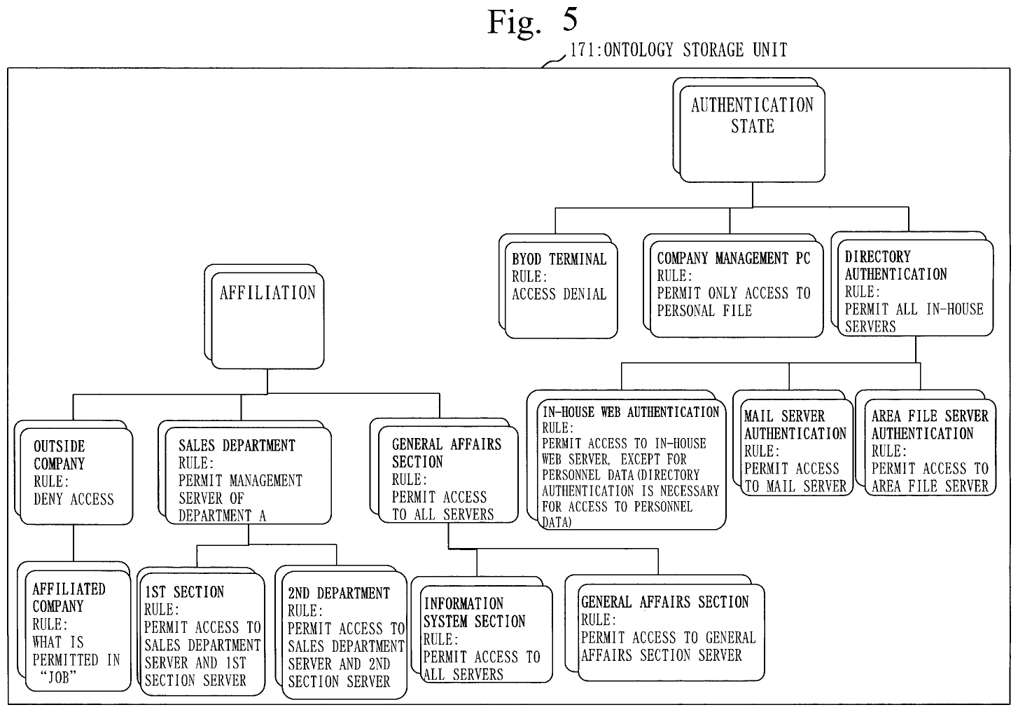

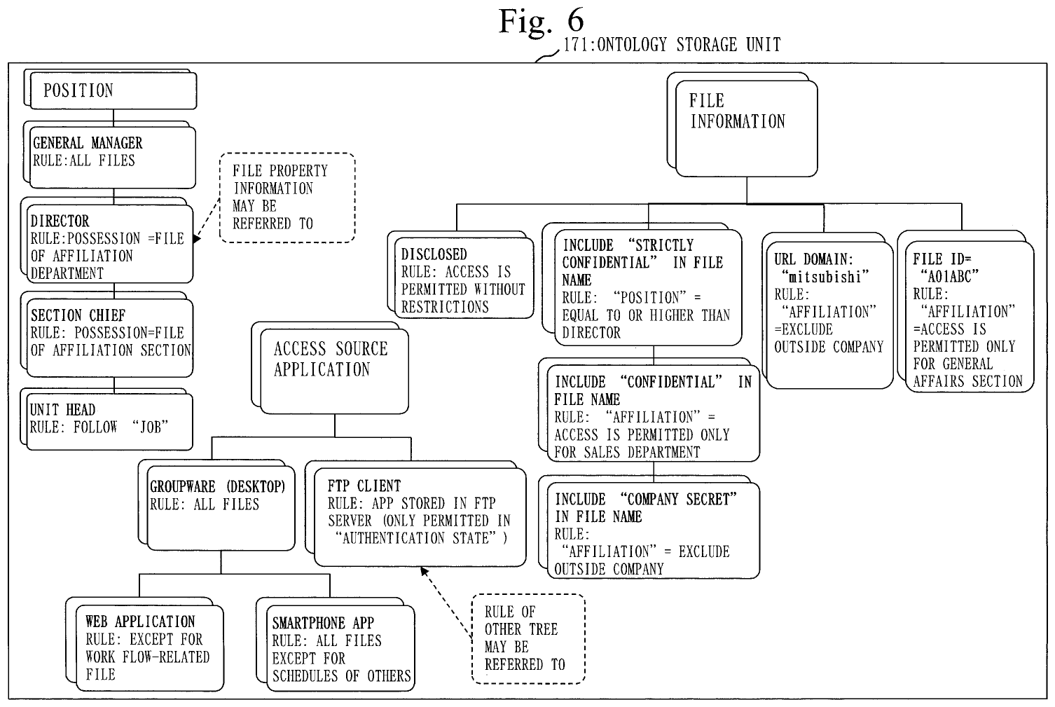

FIG. 4 indicates an ontology 30 of the attribute 31 being “job”, and an ontology 30 of the attribute 31 being “access path”. Apart from those, as illustrated in FIG. 5 and FIG. 6, it is possible to create ontologies 30 of the attributes 31 being “affiliation”, “authentication state”, “post”, “access source application” and “file information”.

In the ontologies 30, each of the access policies 32 is also called a node or a leaf.

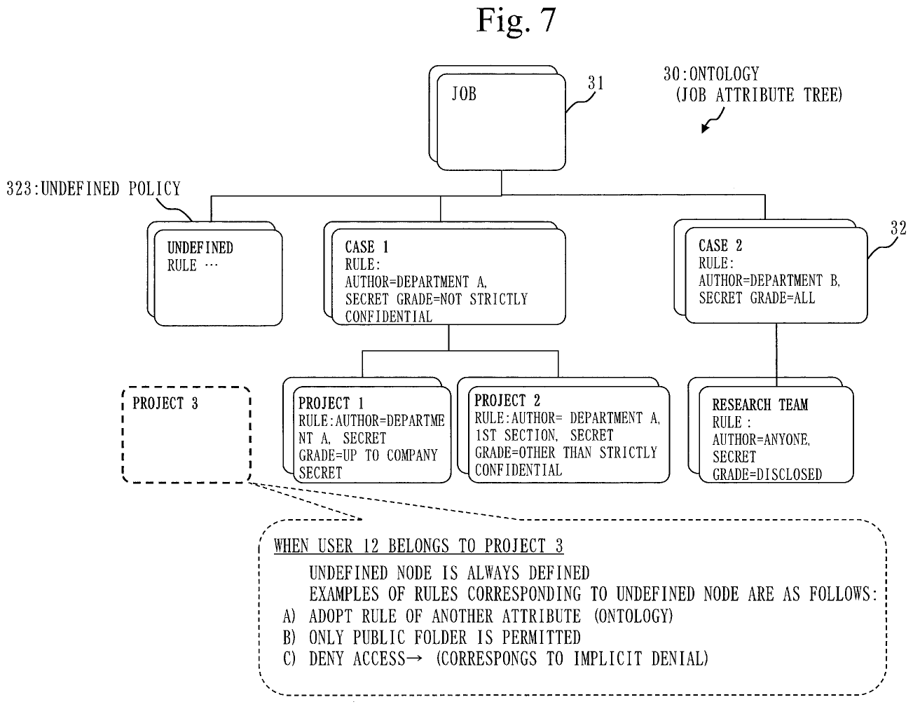

FIG. 7 is a diagram illustrating an example of the undefined policy 323 in the ontology 30 according to the present embodiment.

In FIG. 7, it is assumed that the user 12 that has requested access belongs to Project 3. However, in the ontology 30 of Job in FIG. 7, the access policy 32 in a case of Project 3 is undefined.

The undefined policy 323 describes a policy in a case wherein the access policy is undefined. In the ontology 30, the undefined policy 323 is assumed to be defined.

Examples of policies defined in the undefined policy 323 are as follows:
(A) Adopt a rule of another attribute (ontology)
(B) Permit only a public folder
(C) Deny access (corresponding to implicit denial)

### Application Rule Generation Process

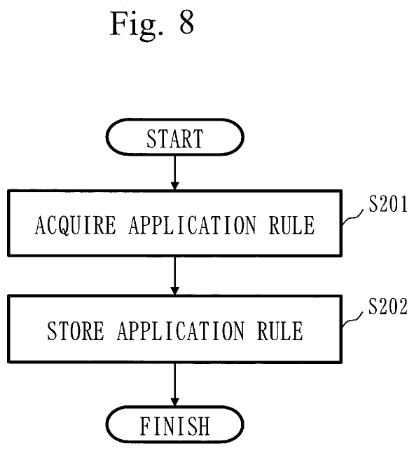

FIG. 8 is a flow diagram illustrating an application rule generation process according to the present embodiment.

In Step S201, the application rule generation unit 120 generates an application rule 40 including a rule at the time when access policies are combined with each other, and a rule at the time when access policies conflict with each other. The application rule generation unit 120 is an interface or a tool used for generation of the application rule 40 by the administrator 11. The administrator 11 inputs the application rule 40 using the application rule generation unit 120.

Generation of the application rule 40 is performed at least before the implementation phase, wherein at least one application rule is registered. The application rule may be registered at an arbitrary timing even after the implementation phase.

As a rule at the time of combining access policies, a rule in the case of combining a plurality of access policy candidates is set. Specifically, it is a priority order such that explicit denial>explicit permission>implicit denial. Otherwise, it is a rule that access policies are ORed, or access policies are ANDed.

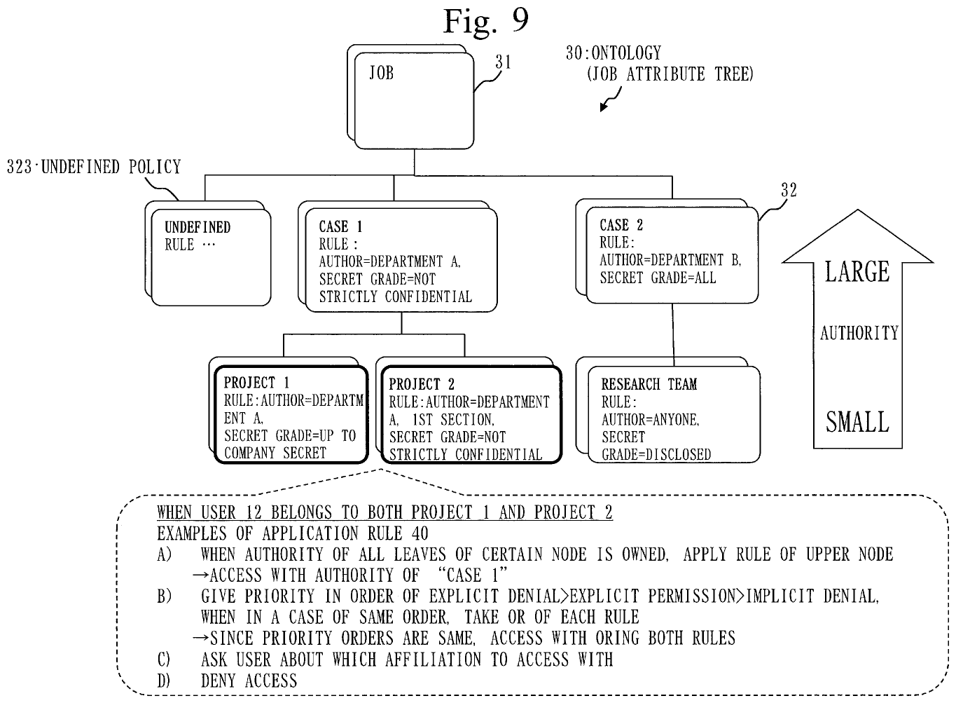

FIG. 9 is a diagram illustrating an example of a rule at the time when access policies in an application rule conflict with each other according to the present embodiment.

“Access policies conflict with each other” means that the rules of a plurality of access policies contradict each another.

In the example of FIG. 9, as an example of access policies conflicting with each another, a case is given wherein the user 12 belongs to both of Project 1 and Project 2.

An example of the application rule 40 is as follows:
(A) When authority of all leaves of a certain node is held, a rule of an upper node is applied→access with authority of Case 1
(B) Give priority in the order of explicit denial>explicit permission>implicit denial; and when they are in the same order, take OR of each rule→since the priority orders are the same, access with ORing both the rules
(C) Ask a user about which affiliation to access with
(D) Deny access

There is also a pattern where both conflict and being undefined occur.

For example, a policy of the undefined policy 323 is assumed to be “implicit denial”. When the user 12 belongs to Project 1 and Project 3, the rule of the undefined node and the rule of Project 2 conflict with each other. Since (C) is implicit denial, when the application rule (B) at the time of conflict is used, the rule of Project 2 takes priority.

In Step S201, the application rule generation unit 120 stores the application rule 40 in the application rule storage unit 172.

### Implementation Phase

### Policy Candidate Extraction Process

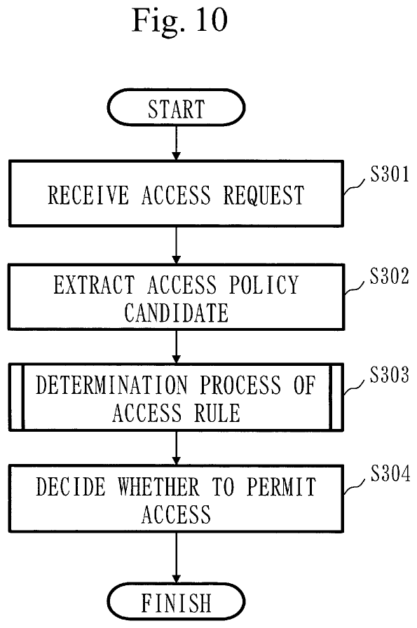

FIG. 10 is a flow diagram illustrating an implementation phase according to the present embodiment.

In Step S301, the access request reception unit 130 receives an access request 51 to the file 21. The access request 51 includes a plurality of attributes 31.

The access request reception unit 130 receives the access request 51 from the user 12. The access request 51 is assumed to include attribute information related to an access condition to decide whether access is permitted. For example, the attribute information is configured by information as follows:
information on user: user ID, user name, affiliation, post
information on access object file: file ID, file name, file property, URL, author
access source application information: business-use Web application, business-use desktop application, business-use smartphone application, FTP application
access path information: in-house, ex-company, own seat, shared area, VPN (virtual private network), one's house, public wireless LAN, authentication state: PC (personal computer) being logged in, mail server being authenticated, VPN being authenticated, directory being authenticated

In Step S302, the policy candidate extraction unit 140 acquires the access request 51, and extracts an ontology including the attribute 31 included in the access request 51 from a plurality of ontologies as an access policy candidate 301.

Specifically, the policy candidate extraction unit 140 extracts the ontology including the attribute 31 included in the access request 51 from the ontology storage unit 171 as the access policy candidate 301.

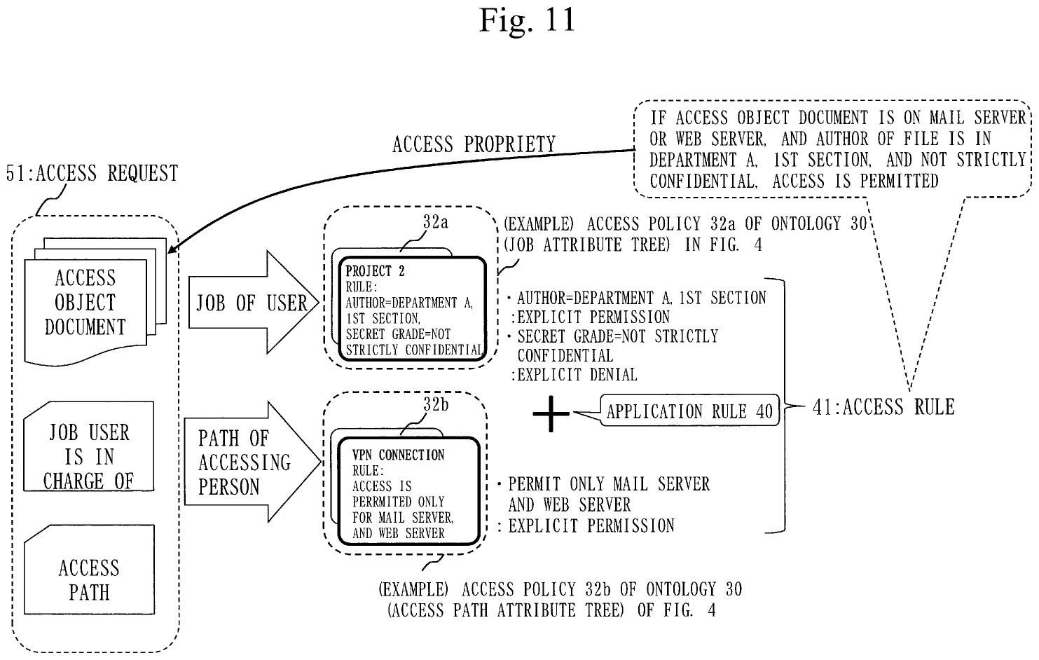

FIG. 11 is a schematic diagram illustrating a concrete example of an implementation phase according to the present embodiment.

In FIG. 11, the access request 51 is assumed to include the file 21 being the access object document, a job of the user 12 and an access path as the attribute 31. It is assumed that the job of the user 12 is Project 2, and the access path is VPN connection.

The policy candidate extraction unit 140 extracts an ontology 30 wherein each of “job” and “access path” being the attribute 31 included in the access request 51 is an attribute 31 as an access policy candidate 301, from the ontology storage unit 171.

Two ontologies in FIG. 4 are extracted as the access policy candidates 301.

### Access Rule Determination Process

In Step S303, an access rule determination process by the access rule determination unit 150 is performed.

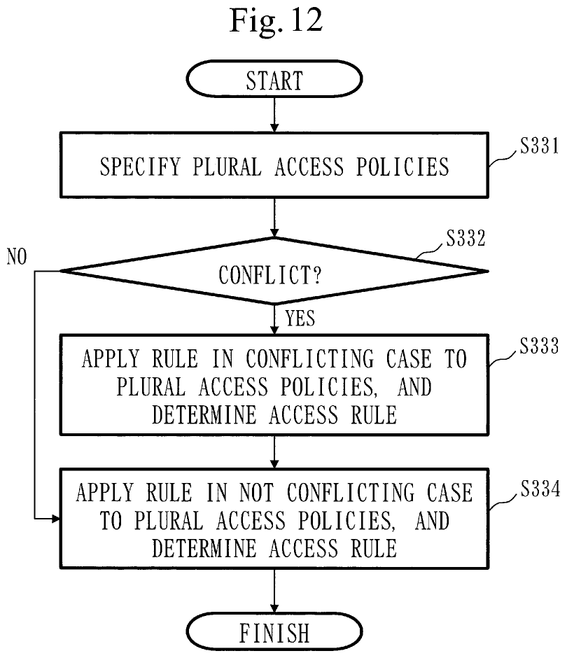

FIG. 12 is a detailed flow diagram of the access rule determination process according to the present embodiment.

In Step S331, the access rule determination unit 150 specifies a plurality of access policies 32 that match the attribute 31 included in the access request 51 from the access policy candidates 301.

In the examples of FIG. 4 and FIG. 11, the access rule determination unit 150 specifies the access policy 32 that matches “job is Project 2” included in the access request 51 from the ontology 30 of “job”. Further, the access rule determination unit 150 specifies the access policy 32 that matches “access path is “VPN connection”” included in the access request 51, from the ontology 30 of “access path”.

In the examples of FIG. 4 and FIG. 11, an access policy 32a of “author=Department A, Division 1: explicit permission, secret level=other than strictly confidential: explicit denial” and an access policy 32b of “only a mail server or a Web server is permitted: explicit permission”.

When an access policy that matches the attribute 31 included in the access request 51 is not defined in the access policy candidates 301, the access rule determination unit 150 specifies the undefined policy 323 as one of the plurality of access policies.

For example, as illustrated in FIG. 7, when the access policy 32 that matches “job is Project 3” included in the access request 51 is not defined, the access rule determination unit 150 specifies the undefined policy 323.

Further, there is also a case wherein the attribute 31 included in the access request 51 corresponds to a plurality of access policies 32. In this case, all the relevant access policies 32 are specified. Specifically, as illustrated in the example of FIG. 9, it is the case wherein the user 12 belongs to both of Project 1 and Project 2.

In Step S332 through Step 334, the access rule determination unit 150 applies the application rule 40 to the plurality of access policies 32, and determines the access rule 41 for the file 21.

Specifically as follows.

In Step S332, the access rule determination unit 150 determines whether the plurality of access policies 32 conflict with each other. The case wherein the plurality of access policies 32 conflict with each other is as described in the example of FIG. 9.

When the plurality of access policies 32 conflict with each other, the procedure proceeds to Step S333. When the plurality of access policies 32 do not conflict with each other, the procedure proceeds to Step S334.

In Step S333, since the plurality of access policies 32 conflict with each other, the access rule determination unit 150 applies the rule at the time when access policies conflict with each other from among the application rules 40 to the plurality of access policies 32, and determines the access rule 41.

In Step S334, since the plurality of access policies 32 do not conflict with each other, the access rule determination unit 150 applies the rule at the time of combining access policies among the application rules 40 to the plurality of access policies 32, and determines the access rule 41.

In the example of FIG. 11, the access policy 32a of “author=Department A, 1st Section: explicit permission, secret level=other than strictly confidential: explicit denial” and the access policy 32b of “only a mail server or a Web server is permitted: explicit permission” are specified.

Further, among the application rules 40, the rule at the time of combining access policies is assumed to be (B) in FIG. 9. Thus, the access rule determination unit 150 applies a rule that “give priority in an order of explicit denial>explicit permission>implicit denial, and when they are in the same order, take OR of each rule” to the access policy 32a and the access policy 32b.

In this manner, the access rule determination unit 150 determines the access rule 41 such that “if an access object document is on a mail server or a Web server, and if a file author is in Department A, 1st section, and the secret level is other than strictly confidential, access is permitted.”

### Propriety Decision Process

In Step S304, the propriety decision unit 160 decides whether access to the file 21 is permitted based on the access rule 41. Specifically, the propriety decision unit 160 decides whether access to the file 21 being the access object document is permitted in response to the access request 51 from the user 12 using the access rule 41. The propriety decision unit 160 sends a reply of a decision result to the user 12.

In the example of FIG. 11, with respect to the access request 51, the job of the user 12 being a request source is Project 2, and the access path is VPN connection. Thus, since the access rule 41 as described above is fulfilled when the access object document is on a mail server or a Web server, and when the author of the file belongs to Department A, 1st Section, and the secret level is other than strictly confidential, the propriety decision unit 160 sends a reply of a decision result of being permitted to access to the user 12.

### Other Configurations

### First Variation

In the present embodiment, the functions of the ontology generation unit 110, the application rule generation unit 120, the access request reception unit 130, the policy candidate extraction unit 140, the access rule determination unit 150 and the propriety decision unit 160 are realized by software. As an example of variation, the functions of the ontology generation unit 110, the application rule generation unit 120, the access request reception unit 130, the policy candidate extraction unit 140, the access rule determination unit 150 and the propriety decision unit 160 may be realized by hardware components.

Specifically, the access decision device 100 includes an electronic circuit 909 instead of the processor 910.

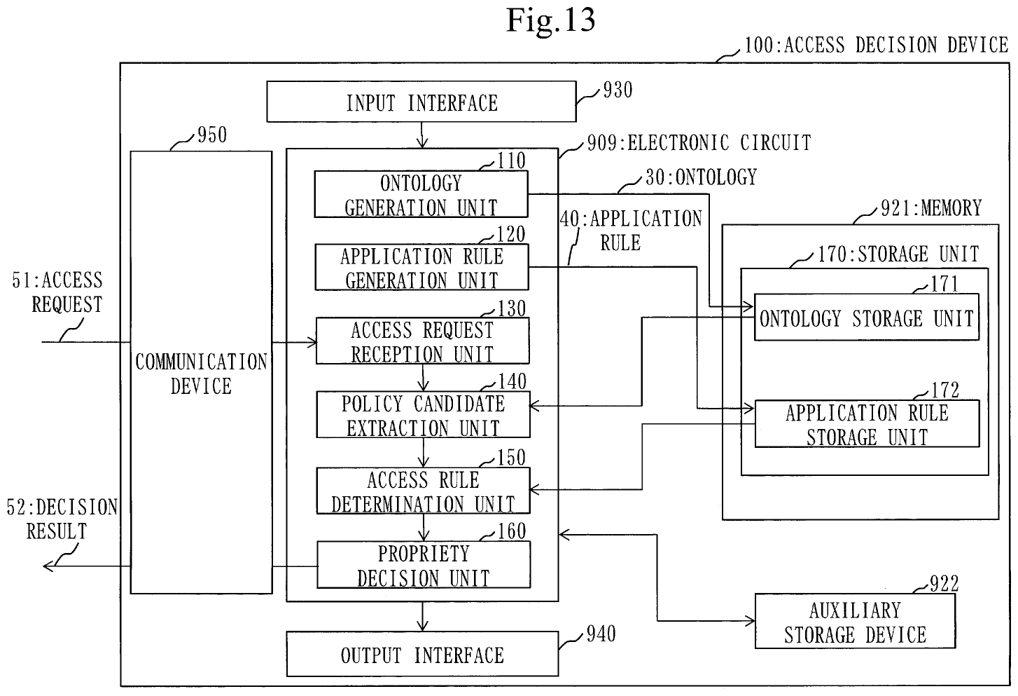

FIG. 13 is a diagram to illustrate a configuration of the access decision device 100 according to a first variation of the present embodiment.

The electronic circuit 909 is dedicated electronic circuitry to realize the functions of the ontology generation unit 110, the application rule generation unit 120, the access request reception unit 130, the policy candidate extraction unit 140, the access rule determination unit 150 and the propriety decision unit 160.

The electronic circuit 909 is, for example, a single circuit, a composite circuit, a processor that is made into a program, a processor that is made into a parallel program, a logic IC, a GA, an ASIC, and an FPGA. GA is an abbreviation for gate array. ASIC is an abbreviation for application specific integrated circuit. FPGA is an abbreviation for field-programmable gate array.

The functions of the ontology generation unit 110, the application rule generation unit 120, the access request reception unit 130, the policy candidate extraction unit 140, the access rule determination unit 150 and the propriety decision unit 160 may be realized by one electronic circuit, or may be realized dispersively by a plurality of electronic circuits.

As an example of another variation, a part of the functions of the ontology generation unit 110, the application rule generation unit 120, the access request reception unit 130, the policy candidate extraction unit 140, the access rule determination unit 150 and the propriety decision unit 160 may be realized by an electronic circuit, and the rest of the functions may be realized by software. Further, a part of or all the functions of the ontology generation unit 110, the application rule generation unit 120, the access request reception unit 130, the policy candidate extraction unit 140, the access rule determination unit 150 and the propriety decision unit 160 may be realized by firmware.

Each of the processor and the electronic circuits may be also called processing circuitry. That is, the functions of the ontology generation unit 110, the application rule generation unit 120, the access request reception unit 130, the policy candidate extraction unit 140, the access rule determination unit 150 and the propriety decision unit 160 are realized by processing circuitry.

### Second Variation

In the present embodiment, the ontology 30 is in the tree structure. However, the ontology 30 may be configured to have a graph structure.

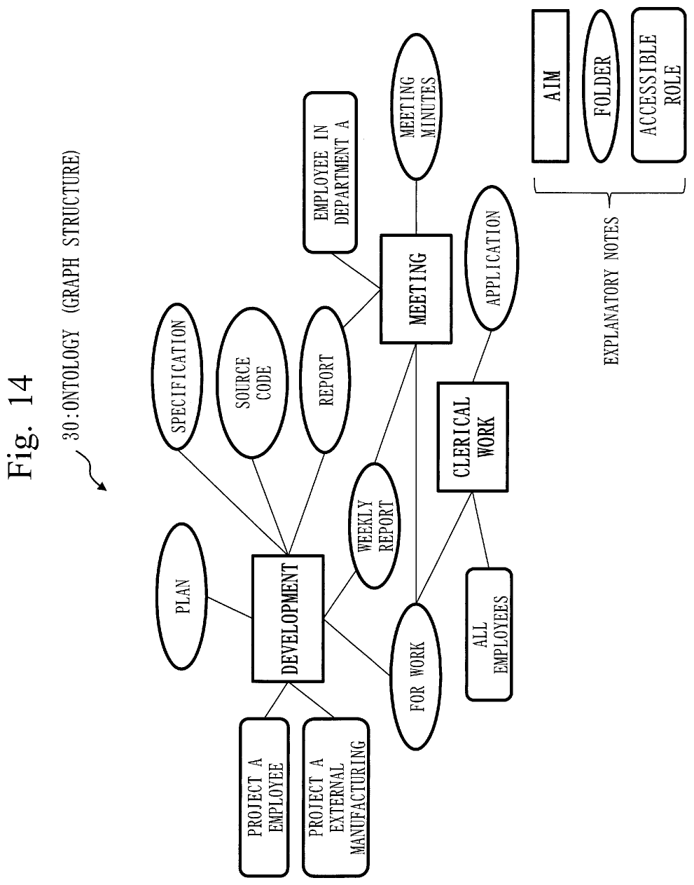

FIG. 14 is a diagram illustrating an example of the ontology 30 according to a second variation of the present embodiment.

In the present embodiment, the example of the ontology 30 in the tree structure has been described.

However, it is also possible to expand the ontology 30 in the graph structure in the second variation into a tree structure and to process the ontology 30 in a similar manner, by specifying a starting point of attributes.

Description will be made using a concrete example of FIG. 14.

As a prior condition, it is assumed that an application being an access means to a file is determined for each aim, and confirmation of user attributes is performed.

It is assumed that an employee in Department A and in charge of Project B accesses a file server.

In a case intended for clerical works, it is possible to access “application”, and “folder for work”.

In a case intended for meetings, it is possible to access “weekly report”, “report” and “minute”.

In a case intended for development, it is impossible to access “plan”, “specification” and “source code”. However, in a case intended for clerical works or meetings, it is possible to access folders of “weekly report”, “report” and “for work”.

A plurality of ontologies 30 in this graph structure are prepared as in a basic operation, and an access policy is determined.

### Third Variation

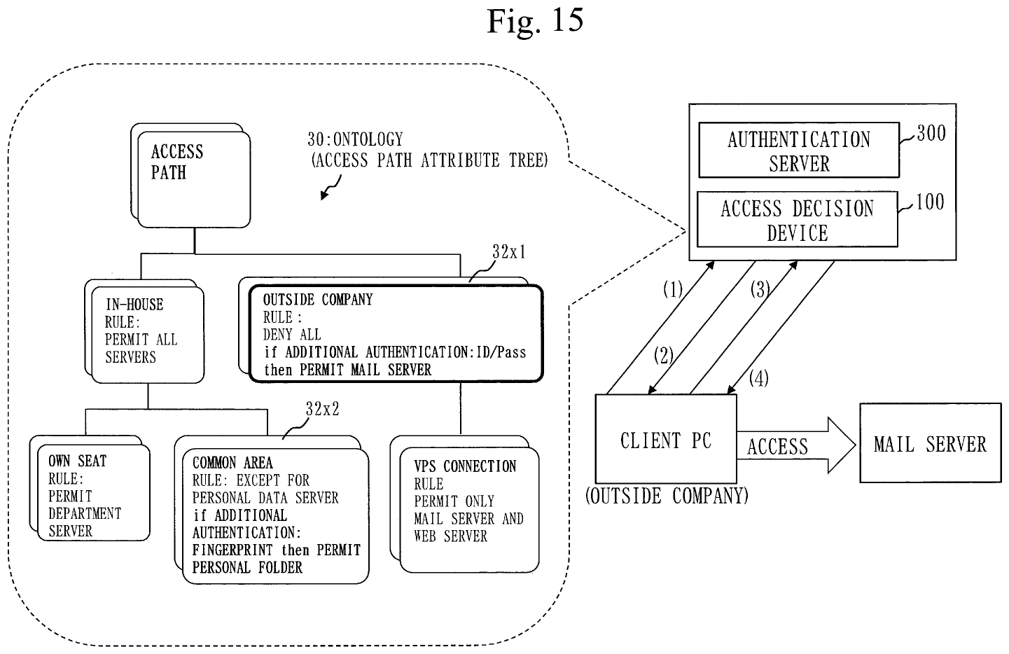

FIG. 15 is a schematic diagram illustrating an access rule determination process according to a third variation of the present embodiment.

Further, as illustrated in FIG. 1, the file access system 500 according to the third variation of the present embodiment includes an authentication server 300 in addition to the access decision device 100 and the file server 200. A mail server is one example of the file server 200.

In the third variation of the present embodiment, it is possible for the ontology generation unit 110 to set an additional condition such as additional authentication as an access condition in the access policy 32.

As illustrated in FIG. 15, it is possible to give a condition of additional authentication to the access policy 32 of the ontology 30. In FIG. 15, a condition of additional authentication that “if additional authentication: ID/Pass then permit mail server” is given to the access policy 32×1. Further, a condition of additional authentication that “if additional authentication: fingerprint then permit individual folder” is given to the access policy 32×2.

In FIG. 15, it is assumed that an additional condition is added to the access policy 32×1, and the access policy 32×1 is specified.
(1) Request access to a mail server from outside the company;
(2) Deny the request since it is from outside the company, and request additional authentication
(3) Transmit information (ID/Pass) of additional authentication
(4) Permit access to the mail server

Flows of (2) and (3) may be not explicitly performed by a user, but may be authenticated in a context.

### Description of Effect of Present Embodiment

By the access decision device 100 according to the present embodiment, it is possible to define an ontology to decide whether access is permitted for each attribute of access; therefore, it is possible to define access patterns without omission. Further, when the access condition is changed, it is possible for the administrator to change the ontology at any time by the ontology generation unit.

Therefore, there is an effect that availability is not impaired even in an error state wherein dynamic access policies conflict with each other.

By the access decision device 100 according to the present embodiment, in order to evaluate propriety of access at the time when a file access occurs; therefore, an access policy in accordance with an attribute of a file at the point of time of access and an attribute of an access condition is applied. Thus, it is possible to follow the access policy even when the content of the file to be accessed is rewritten, or the attribute of access is changed.

By the access decision device 100 according to the present embodiment, “ontology” being a structural framework is used, and the dynamic access policy is formally represented in an ontology.

(1) It is possible to configure an explainable ontology by organizing access conditions. Specifically, it is possible to organize an access policy template by attributes such as an access object person, a file attribute, a file content, time and an access path.

(2) Once an ontology is created, it is possible to suppress an inference cost.

An access policy template (ontology) is generated from a rule such as an administrative regulation. Rules do not change often; therefore, once the ontology is created, reconsideration is hardly necessary.

(3) With respect to the ontology, an application rule in an error state is obvious.

The ontology is characterized in that it is possible to define error states without omission. It is possible to set an application rule (privilege, default) at the time of error state.

(4) With respect to the ontology, it is possible to organize and define conditions for access.

It is possible to describe conditions not only on file contents but also on an attribute of the author or whether approval has been received from a senior, etc.

When the ontology is made into a tree structure, it is necessary to define a search rule of a path in order to attain an end condition (node), regardless of an end point. For example, it is such a definition that in a case of “job” tree, when an affiliation of a user is “Case 1,” “Case 1” node becomes an end point, and when the affiliation is “Case 1/Project 1,” the tree structure is traced to “Project 1” node. A user who matches the affiliation “Case 1” is a manager who integrates Project 1 and Project 2. As described, an upper node is assigned to a person with a stronger privilege.

### Second Embodiment

In the present embodiment, description is made mainly on points different from those in the first embodiment, and on points added to the first embodiment.

In the present embodiment, components having functions similar to those in the first embodiment are denoted by same reference numerals, for which description is omitted.

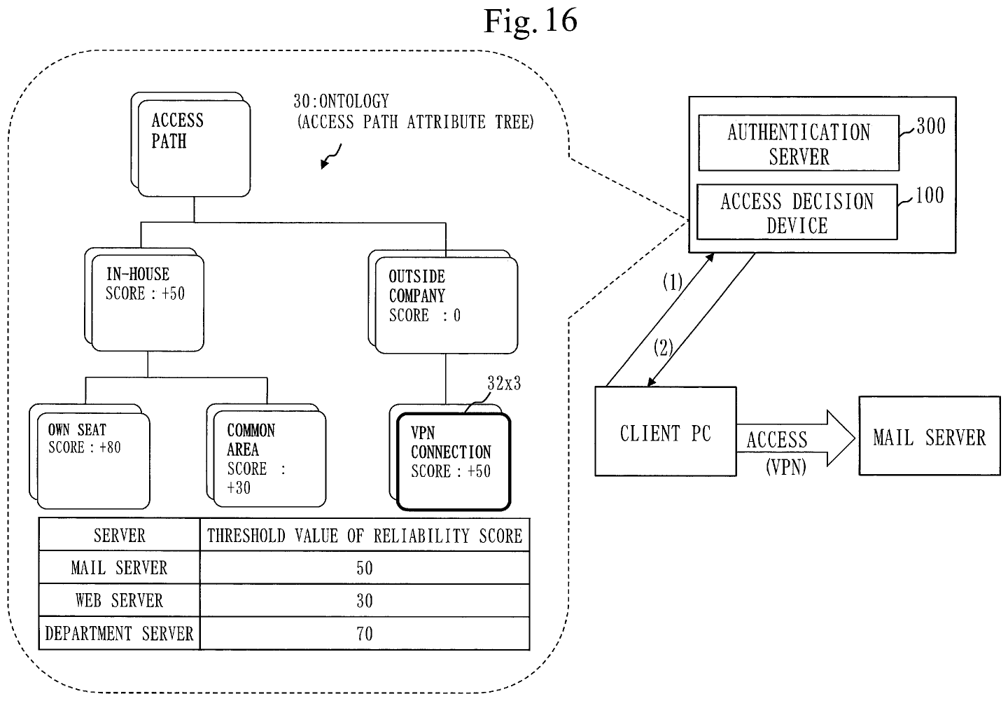

FIG. 16 is a schematic diagram illustrating an example of the ontology 30 according to the present embodiment.

In the present embodiment, it is possible for the ontology generation unit 110 to set a reliability score representing reliability of access as an access condition described in the access policy 32.

There is a system to set a reliability score in the access policy 32 being a tree node, and to permit access based on the reliability score, depending on the type of data.

In FIG. 16, a reliability score is set in the access policy 32.

Further, it is assumed that an access policy 32×3 is specified.

(1) Request access to a mail server via a VPN.

(2) Since it is via the VPN, the reliability score is 50. Since the reliability score necessary to access a mail server is 50, permit access to the mail server.

It is also acceptable to combine the first embodiment and the third variation, and to enhance the reliability score with an additional authentication request.

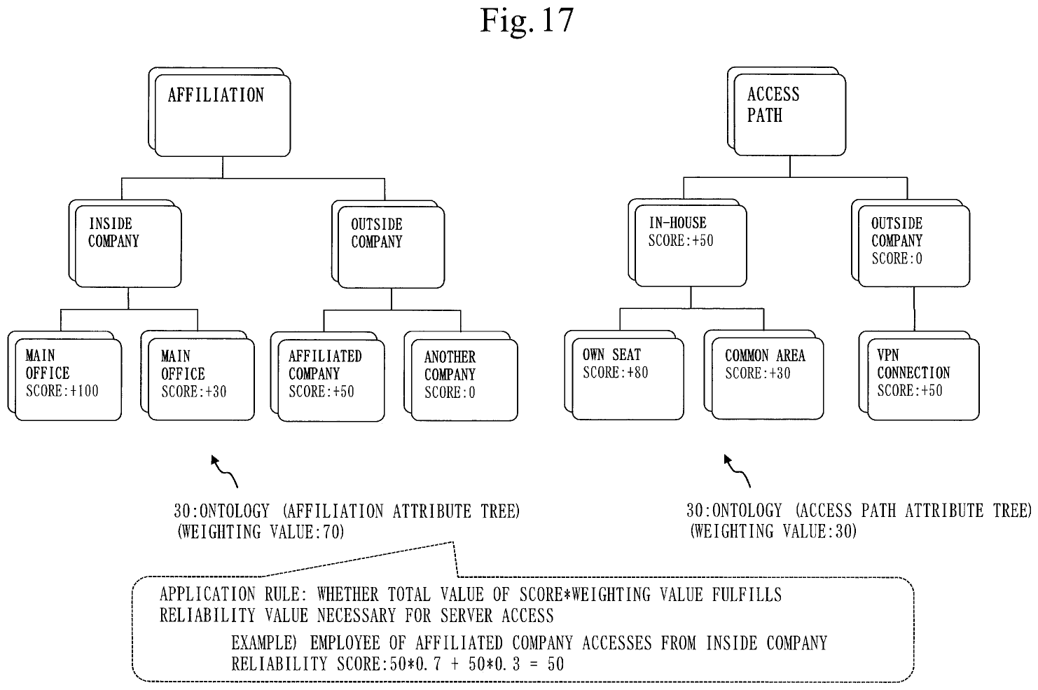

FIG. 17 is a diagram to illustrate another example of the ontology 30 according to the present embodiment.

Further, it is possible for the ontology generation unit 110 to set a weighting value in each ontology of a plurality of ontologies, and to calculate a score obtained by multiplying the reliability score by the weighting value as a final reliability score.

The weighting value represents a weight of evaluation.

For example, the application rule 40 is assumed to be “whether a total value of score*weighting fulfills a reliability value necessary for accessing a server”.

In the example of FIG. 17, it is assumed that an employee of an affiliated company accesses from inside an office. In this case, the reliability score becomes 50*0.7+50*0.3=50. Thus, when the reliability score “50” fulfills the reliability value necessary for accessing the server, access is permitted.

### Third Embodiment

In the present embodiment, description is made mainly on points different from those in the first and the second embodiments, and points added to the first embodiment.

In the present embodiment, components including functions similar to those in the first and second embodiments are denoted by same reference numerals, for which description is omitted.

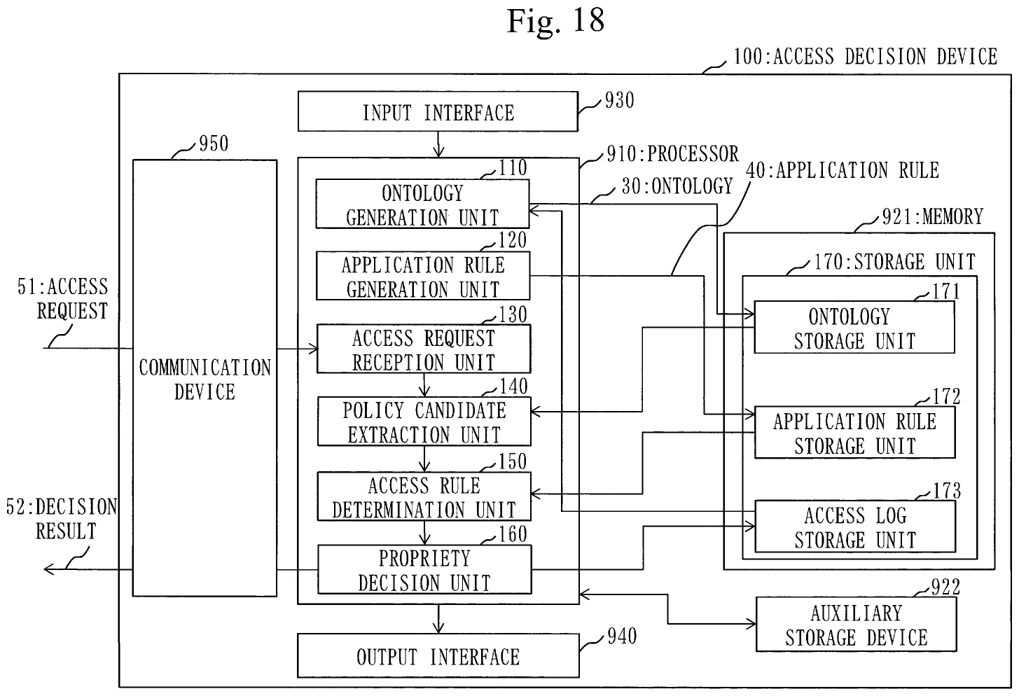

FIG. 18 is a diagram illustrating a configuration example of the access decision device 100 according to the present embodiment.

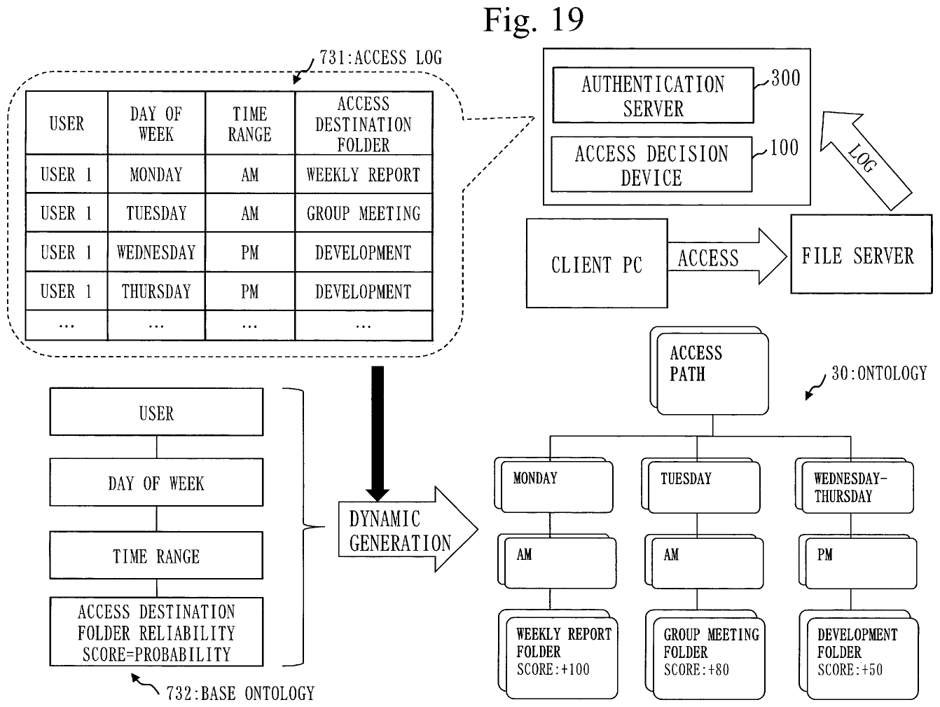

FIG. 19 is a schematic diagram illustrating an example of an ontology generation process and an access rule determination process according to the present embodiment.

The access decision device 100 according to the present embodiment includes an access log storage unit 173 in the storage unit 170 in addition to the configuration described in the first embodiment.

In the present embodiment, the ontology generation unit 110 generates an ontology dynamically using a base ontology 732 being a base layer representing a base of a hierarchical structure of an ontology and an access log 731 being an access log to a file. The base ontology 732 is created by the administrator.

The access log storage unit 173 stores an access request of a user and the decision result as the access log 731.

The ontology generation unit 110 generates the ontology 30 dynamically using the access log 731 and the base ontology 732. Specifically, the ontology generation unit 110 analyzes a pattern to access a file or a folder by days of the week from the access log 731, and automatically constructs the ontology 30. As for a method to generate the ontology 30 dynamically, a method described in “Dynamic Is-a Hierarchy Generation based on Viewpoints, KOZAKI, Kouji; HIHARA, Keisuke; and MIZOGUCHI, Riichiro, Transactions of the Japanese Society for Artificial Intelligence, Vol. 27, No. 3, pp. 235-244 (2012)” for example, may be adopted.

In the first through third embodiments as described above, file access has been shown as an example; however, it may be extended to access to a specific “function”. Access objects may be “mail function”, “schedule”, “in-house web”, or “development environment”.

In the first through third embodiments as described above, each unit of the access decision device has been described as an independent functional block. However, the configuration of the access decision device does not have to be the configuration as in the embodiments described above. The functional blocks of the access decision device may have any configuration as long as the functional blocks can realize the functions described in the embodiments described above. Further, the access decision device may be a system composed of a plurality of devices instead of one device.

In addition, a plurality of parts of the first through third embodiments may be combined and implemented. Alternatively, one part of these embodiments may be implemented. In addition, these embodiments may be implemented in any combination as a whole or partially.

That is, in the first through third embodiments, it is possible to freely combine each embodiment, modify any components of each embodiment, or omit any components in each embodiment.

The embodiments as described above are essentially preferred examples, and are not intended to limit the scope of the present invention, the scope of application of the present invention, and the scope of use of the present invention. The embodiments as described above can be variously modified as needed.

### REFERENCE SIGNS LIST

11: Administrator; 12: user; 30: ontology; 301: access policy candidate; 31: attribute; 32, 32a, 32b32×1, 32×2, 32×3, 32×4: access policy; 323: undefined policy; 40: application rule; 41: access rule; 51: access request; 52: decision result; 100: access decision device; 110: ontology generation unit; 120: application rule generation unit; 130: access request reception unit; 140: policy candidate extraction unit; 150: access rule determination unit; 160: propriety decision unit; 170: storage unit; 171: ontology storage unit; 172: application rule storage unit; 173: access log storage unit; 731: access log; 732: base ontology; 909: electronic circuit; 910: processor; 921: memory; 922: auxiliary storage device; 930: input interface; 940: output interface; 950: communication device

1. An access decision device to decide propriety of access to a file, the access decision device comprising:
processing circuitry
to generate information that represents an access policy to describe an access condition for each attribute of access in a hierarchical structure as a plurality of ontologies,
to generate an application rule that includes a rule in a case of combining access policies, and a rule in a case wherein access policies conflict with each other,
to acquire an access request being an access request for the file, which includes a plurality of attributes, and to extract as an access policy candidate an ontology that includes an attribute included in the access request from the plurality of ontologies,
to specify a plurality of access policies that match the attribute included in the access request from the access policy candidate, to apply the application rule to the plurality of access policies, and to determine an access rule for the file, and
to decide propriety of access to the file based on the access rule.

2. The access decision device as defined in claim 1, wherein
each ontology of the plurality of ontologies includes an undefined policy that describes a policy in a case wherein an access policy is undefined, and
when an access policy that matches the attribute included in the access request is not defined in the access policy candidate, the processing circuitry specifies the undefined policy as one of the plurality of access policies.

3. The access decision device as defined in claim 1, wherein the processing circuitry decides whether the plurality of access policies conflict with each other, and when the plurality of access policies do not conflict with each other, applies the rule in the case of combining the access policies to the plurality of access policies, and determines the access rule.

4. The access decision device as defined in claim 3, wherein when the plurality of access policies conflict with each other, the processing circuitry applies the rule in the case of combining the access policies to the plurality of access policies, and determines the access rule.

5. The access decision device as defined in claim 1, wherein the hierarchical structure of each of the plurality of ontologies is in a tree structure or a graph structure.

6. The access decision device as defined in claim 1, wherein the processing circuitry is capable of setting an additional condition as the access condition described in the access policy.

7. The access decision device as defined in claim 1, wherein the processing circuitry is capable of setting a reliability score representing reliability of access as the access condition described in the access policy.

8. The access decision device as defined in claim 7, wherein the processing circuitry is capable of setting a weighting value in each ontology of the plurality of ontologies, and calculates a score obtained by multiplying the reliability score by the weighting value as a final reliability score.

9. The access decision device as defined in claim 1, wherein the processing circuitry generates each of the plurality of ontologies dynamically using a base layer representing a base of the hierarchical structure of each of the plurality of ontologies and a log of access to the file.

10. An access decision method used by an access decision device to decide propriety of access to a file, the access decision method comprising:
generating information that represents an access policy to describe an access condition for each attribute of access in a hierarchical structure as a plurality of ontologies;
generating an application rule that includes a rule in a case of combining access policies, and a rule in a case wherein access policies conflict with each other;
acquiring an access request being an access request for the file, which includes a plurality of attributes, and extracting as an access policy candidate an ontology that includes an attribute included in the access request from the plurality of ontologies;
specifying a plurality of access policies that match the attribute included in the access request from the access policy candidate, applying the application rule to the plurality of access policies, and determining an access rule for the file; and
deciding propriety of access to the file based on the access rule.

11. A non-transitory computer readable medium storing an access decision program to decide propriety of access to a file, the access decision program making a computer perform:
an ontology generation process to generate information that represents an access policy to describe an access condition for each attribute of access in a hierarchical structure as a plurality of ontologies;
an application rule generation process to generate an application rule that includes a rule in a case of combining access policies, and a rule in a case wherein access policies conflict with each other;
a policy candidate extraction process to acquire an access request being an access request for the file, which includes a plurality of attributes, and to extract as an access policy candidate an ontology that includes an attribute included in the access request from the plurality of ontologies;
an access rule determination process to specify a plurality of access policies that match the attribute included in the access request from the access policy candidate, to apply the application rule to the plurality of access policies, and to determine an access rule for the file; and
a propriety decision process to decide propriety of access to the file based on the access rule.
